(19) United States
(12) Patent Application Publication
(10) Pub. No.: US 2001/0006382 A1
(43) Pub. Date: Jul. 5, 2001

(54) Multiple window display system

(76) Inventor: Leonardus Hendricus Maria Sevat, Eindhoven (NL)

Correspondence Address: Philips Electronics North America Corp., 580 White Plains Road, Tarrytown, NY, 10591, US

(21) Appl. No.: 09/741,919

(22) Filed: Dec. 20, 2000

(30) Foreign Application Priority Data
Dec. 22, 1999 (EP) 99204475.0

(51) Int. Cl. G09G 5/00; G09G 5/08

(52) U.S. Cl. 345/169; 345/158

(57) ABSTRACT

The invention relates to a display system comprising a display device capable of displaying information in multiple windows of the display device, enabling the user to select a window for controlling a parameter of said window in response to subsequent user supplied parameter control commands. The display system according to the invention comprises two or more remote controls, and association means for associating a respective remote control with a respective window. Upon reception of a control command from a remote control, the window associated with the remote control is selected, and the control command is applied to the selected window. In this way, multiple users are enabled to independently control a window displayed on the display device.

### FIELD OF THE INVENTION

The invention relates to a display system comprising a display device having window means for displaying information in at least two windows of said display device, parameter control means for controlling a parameter of a respective one of said windows in response to a user supplied parameter control command, and user operable window selection means for selecting a window to be controlled by said parameter control means.

The invention further relates to a display device for use in the above display system, a remote control for use in the above display system, and to a method of controlling a multi-window display system.

### BACKGROUND OF THE INVENTION

A display system of the type defined in the opening paragraph is known from JP 10079989 A (abstract). The known system comprises a display device capable of showing information in a split-screen mode, presenting two windows of equal size and both occupying half of the display screen. A first window occupies the left part of the display screen, while the second window occupies the right part of the display screen. The system comprises window selection means enabling the user to control each window independently with a remote control. To this end, the window selection means have two separate infrared (IR) receivers near the bottom comers of the display screen. The intensities of the IR signals received by the two IR receivers differ from each other depending on the orientation of the remote control. From this difference the display device infers which window the user wishes to control.

### OBJECT AND SUMMARY OF THE INVENTION

It is an object of the invention to provide an improved system and method of the type defined in the opening paragraph. To achieve that goal, the display system according to the invention is characterized in that the display system comprises at least two remote controls, the display system comprising association means for associating a respective remote control with a respective window, the window selection means being adapted to select the window in response to a parameter control command received from a remote control associated with the selected window. It is thus achieved that multiple users can use a separate remote control for controlling any one of the windows displayed on the display screen. For example, in a split screen mode, the left window is associated with a first remote control operated by a first user, while the right window is associated with a second remote control operated by a second user. Consequently, the first and second user are capable of independently controlling the left and the right window respectively, without the need to explicitly select the window to be controlled. Conflicts arising from simultaneously transmitted IR commands by the at least two remote controls may, for example, be resolved by simply ignoring such simultaneously transmitted commands or processing only the IR signals having the highest intensity.

An embodiment of the display system according to the invention is characterized by the display device being capable of receiving information from different sources and displaying the information from each of said sources in a respective window, said parameter being the source of the information displayed in said respective window. For example, in a television receiver capable of displaying programs broadcast by different TV channels in a split-screen mode, two users can select programs independently for both windows. The programs may, for example, be received from an antenna, a cable network, a satellite dish, a DVD player or a recording device. The display system according to the invention thus provides each user with his own ‘zapping’ environment. In addition to the source of the displayed information, parameters such as brightness, contrast, sound level, etc. may also be controlled in this way.

An embodiment of the display system according to the invention is characterized by said association means comprising, in each respective remote control, window identification means for transmitting, along with a transmitted parameter control command, a signal indicative of a window associated with the respective remote control. For example, the windows displayable by the system may be numbered in a range from one to the number of displayable windows. Each remote control may then have means for associating the remote control with one of the window numbers, by transmitting an IR signal representing said window number along with any transmitted control command for controlling a parameter of the associated window. For example, said IR signal may be transmitted as a prefix to each parameter control command. The desired window number may be user supplied, and stored in non-volatile memory. Upon reception of the IR signals comprising the prefix and the parameter control command, the display device first selects the appropriate window and subsequently applies the parameter control command to the selected window. Instead of identification by a number, windows may be identified in other ways, for example, by a character string, screen coordinates etc.

An alternative embodiment of the display system according to the invention is characterized by said association means comprising discrimination means for discriminating signals received from said at least two remote controls so as to determine from which remote control the received signals originate. Once it has been determined from which remote control the received IR signals originate, the associated window is looked up, and the received parameter control command is applied to the associated window. Various methods of discriminating signals from different remote controls may be applied.

An embodiment of the display system according to the invention is characterized by said at least two remote controls being arranged to transmit signals in accordance with different protocols, the discrimination means being arranged to recognize said different protocols. For this purpose, the display device may comprise two distinct IR receivers each capable of decoding a different IR protocol, for example, in respect of IR frequency, bit length etc. Alternatively, the display device comprises one IR receiver capable of receiving and decoding multiple IR protocols.

An alternative embodiment of the display system according to the invention is characterized by said association means comprising, in each respective remote control, remote control identification means for transmitting, along with a transmitted parameter control command, a signal identifying the respective remote control. Such an identification signal may be stored in the remote control in advance by the manufacturer, but advantageously, the remote control enables the user to select a respective one of a set of predetermined identities. For example, the user may assign a unique number to each of the available remote controls. Such a number, identifying the remote control, may be transmitted along with each parameter control command, for example, as a prefix. The display device is then capable of determining which remote control transmitted the parameter control command, look up the associated window and control the appropriate parameter of the associated window.

An embodiment of the display system according to the invention is characterized by the window selection means being arranged to bypass said association means when only one window is displayed on the display device. In this way it is achieved that each remote control can be used to control the main image when the window means are not operative. For example, if, in a multi-window mode, one of two users deactivates the multi-window mode and leaves the room, the other user is immediately in control of the main image. As soon as the multi-window mode is re-activated, each remote controls is again associated with a default or previously associated window.

The invention is particularly suitable for a (wide-screen) television receiver comprising a split-screen mode, allowing two users to ‘zap’ independently through the available broadcast channels and to watch the resulting images in a separate part of the screen. Dependent on the screen size and the viewing distance, the number of distinct windows may be increased indefinitely, allowing each member of a household to control his own part of the display screen. If a very large display screen is available, for example a flat screen occupying a substantial part of a wall, the windows may not even be located near each other, thus allowing the display device to provide one window in one part of the room, and another window in another part of the room, both windows being controllable by a separate remote control. The full screen would then be used for video-conferencing and/or watching movies, while the multi-window mode would be applied to serve individual viewers in other situations.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 schematically shows a television system as an embodiment of the display system according to the invention,

FIG. 2 shows a diagram of a television system as an embodiment of the display system according to the invention,

FIG. 3 shows a diagram of a television system as an alternative embodiment of the display system according to the invention.

FIG. 4 shows a flow diagram of an embodiment of the method according to the invention.

### DESCRIPTION OF EMBODIMENTS

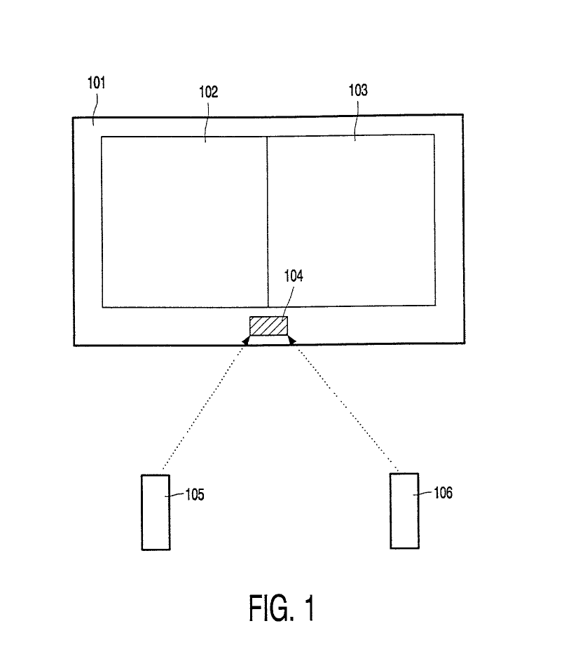

FIG. 1 schematically shows a television system as an embodiment of the display system according to the invention. The television system comprises a television receiver 101 capable of showing video signals broadcast by two different channels in a split screen mode, one channel in a first window 102 on the left half of the screen and the second channel in a second window 103 on the right half of the screen. In addition to video signals from TV channels, also signals obtained from other sources, such as a videorecorder or a video camera, may be displayed in one or both of the windows. The television receiver 101 comprises an infrared (IR) receiver 104 for receiving IR signals from a remote control 105 and a remote control 106. The television receiver 101 is capable of discriminating signals from both remote controls, as described hereinafter, and applying control commands received from the remote control 105 to the window 102, and control commands received from the remote control 106 to the window 103. The location of the remote control 105 and the remote control 106 is not essential, e.g. exchanging their positions would not necessarily change the respective window controlled by them. However, such a feature is not excluded by the present invention. For example, in an advanced embodiment the television receiver 101 is capable of determining the relative positions of the two remote controls, e.g. by comparing and storing the angles of incidence of the IR signals, and of associating the windows accordingly. Each time an IR signals is received, the position is compared with the previously stored positions, so as to detect an exchange of positions. Exchanging the positions of the remote controls will then change the window controlled by each respective remote control, and optionally, exchange each window's parameters, such as the channel displayed.

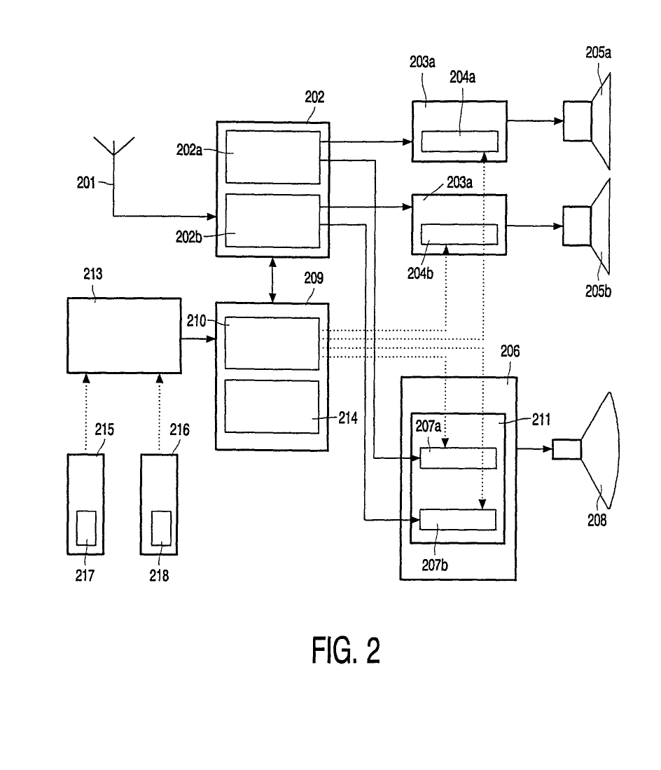

FIG. 2 shows a diagram of a television receiver as an embodiment of the apparatus according to the invention. Television signals from a plurality of channels are received from, for example, an antenna 201, or alternatively from a cable network. A tuner-unit 202 comprises a tuner 202a and a tuner 202b for receiving and decoding signals from two channels simultaneously, in response to commands from a central processing unit 209. The signal of each selected channel is demodulated and split into an audio signal and a video signal. The audio signal is further processed by an audio processor 203a and 203b and loudspeakers 205a and 205b. One or both of the loudspeakers 205a and 205b may be a headphone, enabling two users to simultaneously perceive the sound related to one of the selected channels in an undisturbed way. Each audio processor 203a and 203b comprises an audio parameter controller 204a and 204b, respectively, for controlling audio parameters, such as balance, treble, bass and loudness, in response to control signals from the central processing unit 209. The video signal is further processed by a video processor 206 and displayed on a display screen 208. The video processor 206 comprises window means 211 for displaying video images received from the tuners 202a and 202b in separate windows on the display screen 208, e.g. in a split-screen mode. Parameters of each of these windows can be controlled by a video parameter controller 207a and 207b, respectively, for controlling video parameters, such as brightness, contrast, color, sharpness, noise reduction, dynamic contrast and color enhancement, in response to control signals from the central processing unit 209. The central processing unit 209 comprises a user command processor 210 and a non-volatile memory 214 for storing data, e.g. presets and parameter settings. A user command unit 213 is capable of receiving control commands from a remote control 215 and a remote control 216, and sending said control commands to the central processing unit 209. For example, the user may enter a channel number in order to select the corresponding channel. The channel number is translated by the user command processor into an appropriate command which is used to control the tuner 202a or 202b to tune to the desired channel.

The remote control 215 comprises window identification means 217, and the remote control 216 comprises similar window identification means 218. The window identification means 217 and 218 cause IR control commands transmitted by the remote controls 215 and 216 to be prefixed by a window identification signal identifying a window displayed on the display screen of the television receiver. When a control command is received while the television receiver is in the split-screen mode, the user command unit 213 interprets the window identification signal and transmits a command to the user command processor 210 so as to control the appropriate window in accordance with the window identification signal. If the user command is a channel selection command, the user command processor 210 controls, in dependence on the window identification signal, the tuner 202a or the tuner 202b to select the desired channel, and the window means 211 to display the video signals of that channel in the desired window. The window identification transmitted by the remote controls 215 and 216 may be entered by the user, prestored by the manufacturer, or dynamically altered in dependence on the remote control's position, as described above. The window identification means 217 and 218 thus constitute association means for associating the remote controls 215 and 216 with respective windows. The user command unit 213 and the user command processor 210 constitute window selection means for selecting a window to be controlled in response to the window identification signal supplied by the window identification means 217 and 218, respectively.

If the prefixed window identification signal constitutes a regular control command for selecting a window to be controlled, the television receiver can be a conventional split-screen television capable of selecting a window in response to said regular control command. The association means of the present invention are thus comprised in the remote controls 215 and 215. The user command is issued automatically by the remote controls 215 and 216 comprising the window identification means 217 and 218 according to the invention. Additionally, the user command may still be issued manually, and the remote control may comprise user operable means for bypassing the window identification means to switch off the automatic window selection.

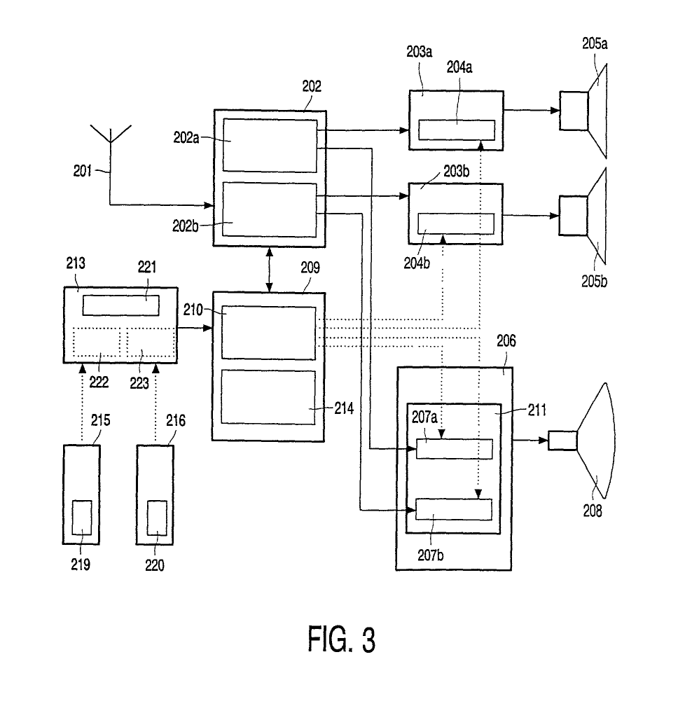

FIG. 3 shows a diagram of a television system as an alternative embodiment of the display system according to the invention. For consistency and ease of understanding, FIG. 3 uses the same reference numerals as in FIG. 2 for items having functions similar to those of the corresponding items in FIG. 2. In the present embodiment the user command unit 213 further comprises discrimination means 221 for discriminating signals received by the user command unit 213 from the remote controls 215 and 216, so as to determine from which remote control the received signals originate. For that purpose, the user command unit 213 comprises, in one embodiment, two distinct IR receivers 222 and 223, each adapted for receiving IR signals from a predetermined remote control, e.g. a remote control transmitting IR signals in accordance with a specific protocol. In an alternative embodiment, each remote control 215 and 216 has, preferably user operable, remote control identification means 219 and 220 for transmitting, along with a control command signal, an identification signal identifying the remote control. Each remote control may thus be assigned an identity, e.g. RC1 and RC2, which identity is transmitted to the television receiver along with each control command. Other ways to discriminate signals from different remote controls may be applied too, e.g. by measuring IR frequency, signal strength etc. In such cases, the remote controls may comprise means to adjust the identifying parameter, so as to uniquely identify the remote control. The discrimination means maintain a table specifying which remote control is assigned to which window on the display screen. This table has a default content, e.g. RC1 controls the left window, while RC2 controls the right window, and the content can be altered by the user by means of the user command unit 213.

As soon as only a main picture is displayed, the association means, embodied by either the window identification means 217 and 218, or the discrimination means 221 in combination with either the distinct IR receivers 222 and 223 or the remote control identification means 219 and 220, are bypassed, thus allowing both remote controls 215 and 216 to control the main picture.

Conflicts between simultaneously received IR signals from different remote controls may be resolved by just ignoring distorted IR signals, or reconstructing the distinct signals using information concerning IR protocol, frequency, angle of incidence, signal strength etc.

Sound related to respective displayed windows may be directed to various output means. For example, the sound of one window may be directed to the loudspeaker of the display device, while the sound of the other windows is directed to respective headphones. Alternatively, the sound of a window may be directed to a loudspeaker which is located close to said window. For example, in a dual-screen mode comprising a left and a right window, the sound related to the left window may be directed to the left loudspeaker, while the sound related to the right window is directed to the right loudspeaker.

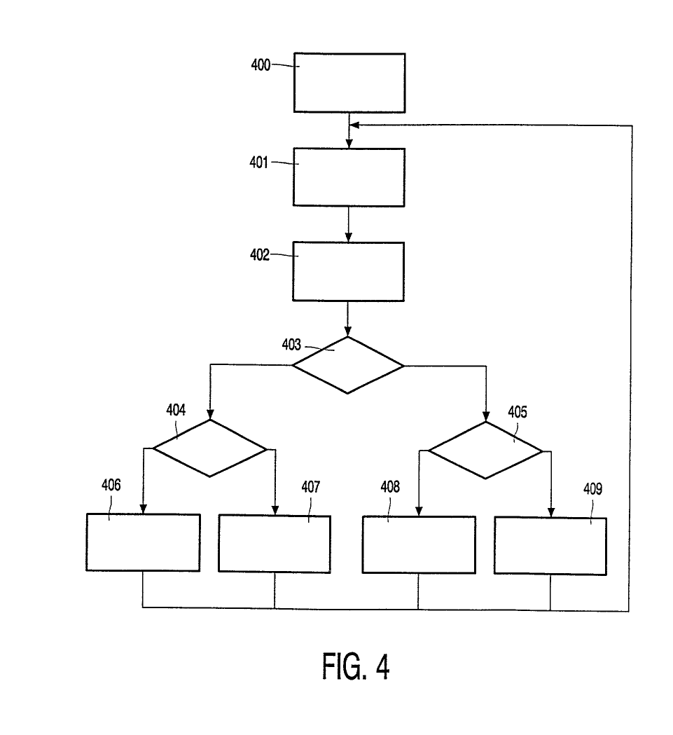

FIG. 4 shows a flow diagram of an embodiment of the method according to the invention. In a step 400 remote controls comprised in the display system are associated with a respective one of two windows of a split screen display device, by programming each remote control to transmit, with each parameter control command, a prefix indicating the associated window. In a step 401 a control command is received from any of the remote controls. In a step 402 the prefix is separated from the remote control command and a window identification is decoded from it. In a step 403, it is determined for which window the received control command is meant, by testing the value of the window identification decoded from the prefix. If the window identity refers to a first window, it is determined in a step 404 whether the control command is a channel selection command. If so, a first tuner coupled with the first window is controlled in a step 406 to tune to the desired channel. Otherwise, the control command is interpreted in a step 407 as a parameter control command for controlling a parameter of the first window, e.g. brightness or contrast. If it is determined that the control command is meant for a second window, it is determined in a step 405 whether the control command is a channel selection command. If so, a second tuner coupled with the second window is controlled in a step 408 to tune to the desired channel. Otherwise, the control command is interpreted in a step 409 as a parameter control command for controlling a parameter of the second window.

In summary, the invention relates to a display system comprising a display device capable of displaying information in multiple windows of the display device, enabling the user to select a window for controlling a parameter of said window in response to subsequent user supplied parameter control commands. The display system according to the invention comprises two or more remote controls, and association means for associating a respective remote control with a respective window. Upon reception of a control command from a remote control, the window associated with the remote control is selected, and the control command is applied to the selected window. In this way, multiple users are enabled to independently control a window displayed on the display device.

Although the invention has been described with reference to particular illustrative embodiments, variants and modifications are possible within the scope of the inventive concept. Thus, for example, instead of remote controls transmitting IR signals, hard-wired remote controls or remote controls transmitting RF signals may be applied. Throughout this specification, a remote control is to be understood as any device which enables a user to remotely control the display device. This includes also a speech recognition unit which is capable of understanding voice commands uttered by a user. In such an embodiment, the speech recognition unit is coupled to the discrimination means, so as to discriminate between voices of different users, which can be accomplished by means of techniques which are known per se, e.g. measuring certain characteristics indicative of a person's voice, such as voice pitch, volume etc. In this way, each user may be associated with, and allowed to control parameters of, a particular window on the display screen.

Instead of, or in addition to, a double tuner, other sources for supplying video information for display in the respective windows may be used, for example, a video recorder, a DVD player, a video camera etc.

The word ‘comprising’ does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

1. A display system comprising a display device having window means for displaying information in at least two windows of said display device, parameter control means for controlling a parameter of a respective one of said windows in response to a user supplied parameter control command, and user operable window selection means for selecting a window to be controlled by said parameter control means, characterized in that the display system comprises at least two remote controls, the display system comprising association means for associating a respective remote control with a respective window, the window selection means being adapted to select the window in response to a parameter control command received from a remote control associated with the selected window.

2. A display system as claimed in claim 1, the display device being capable of receiving information from different sources and displaying the information from each of said sources in a respective window, said parameter being the source of the information displayed in said respective window.

3. A display system as claimed in claim 1, said association means comprising, in each respective remote control, window identification means for transmitting, along with a transmitted parameter control command, a signal indicative of a window associated with the respective remote control.

4. A display system as claimed in claim 1, said association means comprising discrimination means for discriminating signals received from said at least two remote controls so as to determine from which remote control the received signals originate.

5. A display system as claimed in claim 4, said at least two remote controls being arranged to transmit signals in accordance with different protocols, the discrimination means being arranged to recognize said different protocols.

6. A display system as claimed in claim 4, said association means comprising, in each respective remote control, remote control identification means for transmitting, along with a transmitted parameter control command, a signal identifying the respective remote control.

7. A display system as claimed in claim 1, the window selection means being arranged to bypass said association means when only one window is displayed on the display device.

8. A display device for use in a display system as claimed in any one of the preceding claims, comprising window means for displaying information in at least two windows, parameter control means for controlling a parameter of a respective one of said windows in response to a user supplied parameter control command, and user operable window selection means for selecting a window to be controlled by said parameter control means, characterized in that the display device comprises association means for associating a respective one of at least two remote controls with a respective window, the window selection means being adapted to select the window in response to a parameter control command received from a remote control associated with the selected window.

9. A display device as claimed in claim 8, said association means comprising discrimination means for discriminating signals receiving from said at least two remote controls so as to determine from which remote control the received signals originate.

10. A television receiver as a display device as claimed in claim 8 or 9.

11. A remote control for use in a display system as claimed in any one of claims 1 to 7, characterized in that the remote control comprises association means for associating the remote control with a respective window of a display device having window selection means which are adapted to select said respective window in response to a parameter control command received from the remote control, the display device further comprising control means adapted to control a parameter of said respective window in accordance with said parameter control command.

12. A remote control as claimed in claim 11, said association means comprising window identification means for transmitting, along with a transmitted parameter control command, a signal indicative of a window associated with the remote control.

13. A remote control as claimed in claim 11, said association means comprising remote control identification means for transmitting, along with a transmitted parameter control command, a signal identifying the remote control.

14. A method of controlling a multi-window display system, comprising a step of user operably selecting a window, and a step of controlling a parameter of said selected window in response to a user supplied parameter control command, characterized in that the method further comprises a step of associating a respective one of at least two remote controls with a respective window, and a step of selecting the window in response to a parameter control command received from a remote control associated with the selected window.
